(19) United States
(12) Patent Application Publication
(10) Pub. No.: US 2012/0102103 A1
(43) Pub. Date: Apr. 26, 2012

(54) RUNNING LEGACY APPLICATIONS ON CLOUD COMPUTING SYSTEMS WITHOUT REWRITING

(75) Inventors: Neil A. Jacobson, Acton, MA (US); Andrew D. Montgomery, Lexington, MA (US); Kristofer H. Reierson, Acton, MA (US)

(73) Assignee: Microsoft Corporation, Redmond, WA (US)

(21) Appl. No.: 12/908,486

(22) Filed: Oct. 20, 2010

(51) Int. Cl. G06F 15/16

(52) U.S. Cl. 709/204

(57) ABSTRACT

Embodiments of the invention enable an application configured to store certain information (e.g., state information) locally to be deployed to a cloud computing environment in which local storage of such information is not permitted. For example, some embodiments create a “package” of resources that the application expects to be available to it during execution, and makes the package available to the application during execution in the cloud computing environment. The package may provide the application with resources it expects to have available during execution, such as the ability to store state information locally. As a result, the application need not be substantially modified to execute in the cloud computing environment.

### FIELD OF INVENTION

This application relates generally to network-based computing, and more particularly to cloud computing systems.

### BACKGROUND

Cloud computing is a delivery model whereby computing infrastructure, software and information is provided to customers on demand, much like electricity is provided to homes and businesses over the electricity grid. Providers of cloud computing services commonly make dynamically scalable and often virtualized resources available over the Internet, which customers use to deploy applications for access by end users, usually through web-based tools and applications. For example, many cloud computing providers make computing resources (e.g., servers, storage, services, etc.) available to customers, and those customers employ the resources to make their applications available for end user access via the web. The cloud computing model allows customers to avoid the up-front capital expenditures traditionally associated with purchasing computing resources, and pay only for the resources they consume. Given the reduction in up-front costs, one benefit of cloud computing is a low barrier to entry. Other benefits include immediate access to a broad range of resources, improved agility brought about by the ability to rapidly and inexpensively re-deploy applications, location independence that allows for resources to be physically located in geographic areas with lower costs, increased reliability, and easier and less costly application maintenance, since applications need not be installed on each end user's computer, and can thus be more easily supported and improved over time.

Providers of cloud computing services typically make resources available to customers using one of two primary models: the “Platform As A Service” (PAAS) model or the “Infrastructure As A Service” (IAAS) model. PAAS providers typically make an entire computing platform available, including infrastructure and support for applications. In the PAAS model, a customer often uploads an application that is to be made available (“exposed”) to users, defines the number of instances of the application that is to be exposed to users at specified times, and the provider makes sure that the application is up and available at the defined scale. The PAAS provider may set up a virtual environment in which each instance of the application is to execute, maintain the underlying operating system, ensure that antivirus software is executing, perform hardware configuration, etc. The customer simply provides the application and defines the number of instances that are to be made available to users at specified times, and is charged by the provider for the instances, data transfer, storage, input/out requests, IP addresses, etc.

By contrast, IAAS providers typically make infrastructure and virtual environments available to customers, but once the customer enrolls in the service, the customer “owns” and maintains whatever resources are used. Thus, the customer may be responsible for installing and patching the underlying operating system, executing antivirus software, performing hardware configuration tasks, etc.

Often, customers find that the PAAS model offers great benefits, as they are freed from maintaining the infrastructure and underlying platform on which an application executes. Rather, the customer simply develops the application, uploads it to the cloud, and specifies to the provider how many instances should be exposed to users at any one time. The provider takes responsibility for making the application available to end users, coordinating the infrastructure and configuration necessary to make it scalable as defined by the customer, etc.

### SUMMARY

Applicant has recognized that one problem with cloud computing systems is that customers commonly need to substantially modify an application for it to execute properly in a cloud computing environment. For example, many providers of cloud computing systems require that for an application to be deployed to the cloud environment, the application must implement one or more specific interfaces, registered with the cloud computing system, and used to start, stop, reconfigure, and manage the application. Many providers also require that for an application to be deployed to the cloud environment, the application must not store state information on the machine on which it executes. In this respect, application “state” is a collection of information defining the application's current processing, often brought about by user input, which the application accesses during execution to expedite processing. Providers of cloud computing systems typically require that an application not store state on the machine on which it executes because the providers wish to have the flexibility to move the application to another machine with little or no notice. If an application that stores state information on the local machine were moved during execution, that state information might not be available to the application after it is moved to another machine, so the application may cease to function properly. As many applications are configured to store state information on the machine on which it executes, this requirement of cloud computing systems erects a significant barrier to entry for many potential customers.

Accordingly, some embodiments of the invention provide techniques whereby an application (e.g., legacy application) may be deployed to a cloud computing system without having to be substantially modified for the cloud computing environment (e.g., to not store state information locally, or to implement the interface(s) used by the cloud computing system). For example, some embodiments of the invention provide techniques whereby an application, encapsulated using a virtual environment, is provided with a “package” that provides the resources which the application expects to be available to it during execution, including the ability to make certain changes or store certain information (e.g., state information), so that the application need not be substantially modified to execute in a cloud computing environment. For example, in some embodiments of the invention, the package may enable the application to take the actions which the application expects to be able to take to maintain state (e.g., to change registry entries, create files, etc.). In some embodiments, changes attempted by the application are performed on information stored in the package, rather than on the underlying operating system as would be the case if the application were executing in an environment wherein the application were allowed to store state information locally. As a result of being allowed to take the actions which it expects to be able to take, the application continues to function normally, albeit in an environment in which it is not allowed to perform the actions needed to maintain state locally. In some embodiments, a proxy is provided to implement the interface(s) specified by the cloud computing system. The proxy may perform actions on the application based on the instructions received via the cloud computing system, such as to start, stop, reconfigure, or perform other actions on the application). As a result, the application need not be substantially modified to execute properly in a cloud computing environment in which it is not allowed to maintain state information locally.

The foregoing is a non-limiting summary of embodiments of the invention, which are defined by the attached claims.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIG. 1 is a block diagram depicting example components and techniques for creating a package that enables a legacy application to execute in a cloud computing environment, in accordance with embodiments of the invention;

FIG. 2 is a block diagram depicting example components and techniques for deploying a legacy application to a cloud computing environment, in accordance with some embodiments of the invention;

FIG. 3 is a block diagram depicting an example computer system on which embodiments of the invention may be implemented; and

FIG. 4 is a block diagram depicting an example memory on which instructions embodying aspects of the present invention may be stored.

### DETAILED DESCRIPTION

Some embodiments of the invention provide techniques whereby an application that is not configured to execute properly in a cloud computing environment (e.g., because the application is designed to store state information on the machine on which it executes and/or does not implement one or more interfaces specified by the cloud computing system) may be deployed in such an environment without having to be substantially modified. For example, some embodiments of the invention provide techniques whereby an application may be encapsulated within a virtual environment (thereby segregating the application not only from other applications but from the underlying operating system) and provided with a package in which information created by the application, such as but not limited to state information, may be stored and accessed during execution. Because the application is able to access the information which it expects to be available during execution, the application need not be modified to execute in a cloud computing environment. For example, a package implemented in accordance with embodiments of the invention may provide information which supports actions the application expects to be able to make to maintain state. The package may, for example, enable the application requires to perform such actions as changing registry entries, creating files, etc., without the application actually modifying the operating system on the machine on which the application executes. As a result, the application may function normally, even though it is deployed in an environment which does not allow applications to perform actions which the application expects to perform. Additionally, some embodiments provide a proxy to implement one or more interfaces specified by the cloud computing system, to perform actions on the application based on information received from the cloud computing system. The proxy may, for example, perform such actions on the application as starting it, stopping it, reconfiguring it, and/or performing other actions. Thus, the application need not be substantially modified to execute properly in a cloud computing environment.

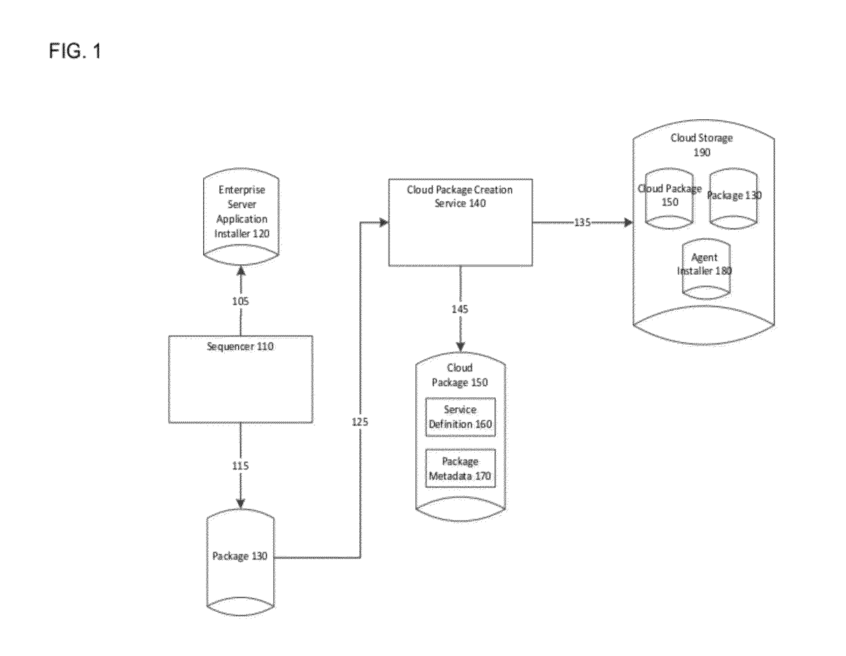

FIG. 1 depicts an example system and technique for creating a package that allows an application that is not configured to run properly in a cloud computing environment to execute in such an environment without substantial modification.

The example system of FIG. 1 includes sequencer 110, which in some embodiments comprises one or more components configured to monitor (as indicated by arrow 105) actions taken by an installer 120 of an enterprise server application. Sequence 110 may be implemented in any of numerous ways, such as via one or more software and/or hardware components. Embodiments of the invention are not limited to implementing sequence 110 in any particular manner.

In the example shown in FIG. 1, sequencer 110 monitors installer 120 to identify actions taken by installer 120 during installation of the enterprise server application, and to identify resources which the application needs to execute properly. Actions monitored by sequencer 110 may comprise any of numerous tasks performed to prepare the application for execution in a non-cloud computing environment, and the resources identified as being needed for proper execution may comprise any of numerous types of resources. For example, in some embodiments, sequencer 110 may identify resources such as registry keys which the application expects to be able to modify during execution, files which the application expects to be able to create or open, data to which the application expects access, etc. As such, the resources extracted by sequencer 110 may include all of those which installer 120 would implement on a machine if the application were installed on that machine.

When sequencer 110 identifies and extracts the resources needed by the application for proper execution, it creates package 130, which may include any or all of the identified resources, and/or derivations thereof. In some embodiments, package 130 may comprise resources and/or derivations for deploying the application in a virtualized environment (i.e., one in which the application executes on a virtual environment, rather than a physical computer). However, embodiments of the invention are not limited in this respect, and package 130 may comprise any suitable representation of resources used by the application during execution. Further, the information included in package 130 may be compiled in any of numerous ways, as the invention is not limited to any particular implementation. In some embodiments, package 130 may comprise one or more objects defining resources identified during the previous step.

Cloud package creation service 140 then takes package 130 as input, as indicated by arrow 125. In the example shown in FIG. 1, cloud package creation service 140 uses package 130 to generate cloud package 150, as indicated by arrow 145. In some embodiments, cloud package 150 includes information used by the application to execute under an application model defined by the cloud computing environment in which the application is to be implemented. An application model may define any of numerous execution and/or configuration parameters, as embodiments of the invention are not limited in this respect. As noted above, an application model may define that an application store no state information on the machine on which it executes. An application model may also define such parameters as one or more specific interfaces, registered with the cloud computing system, which an application must implement, information which the application must generate during execution, and/or other parameters. Embodiments of the invention are not limited to any particular implementation.

In the example shown, cloud package creation service 140 generates cloud package 150 to include service definition 160 and package metadata 170. In the embodiment depicted, service definition 160 and/or package metadata 170 may identify resources that are used by the application during execution, including those identified by sequencer 110. For example, service definition 160 and/or package metadata 170 may specify a port used by the application, its configuration settings, information on a certificate expected or used by the application, and/or any one or more other resources employed by the application. For example, if sequencer 110 detects during monitoring of installer 120 that the application employs port 80 during execution, then service definition 160 and/or package metadata 170 may specify that the cloud environment in which the application is to be deployed should make port 80 available for use by the application. In another example, if sequencer 110 detects that the application uses a certificate to authenticate end users, then service definition 160 and/or package metadata 170 may identify the certificates required so that the cloud environment is capable of processing the specified certificates. Any of numerous types of information may be specified by service definition 160 ad/or metadata 170, as embodiments of the invention are not limited in this respect.

Cloud package 150 may include a proxy which is used to implement one or more interfaces specified by the cloud computing system. The one or more interfaces may enable actions to be performed on the application based on information received from the cloud computing system, such as starting the application, stopping the application, reconfiguring the application, etc. Any suitable interface(s) may be implemented, enabling any suitable action(s) to be performed with respect to an application, as embodiments of the invention are not limited in this respect.

Upon generating cloud package 150, cloud package creation service 140 uploads cloud package 150, package 130 (created by sequencer 110, as described above) and installer 180 to cloud storage 190 (as indicated via arrow 135). In some embodiments, installer 180 includes executable modules and data configured so that, when the executable modules are executed, the application that is to be deployed to the cloud is installed. However, the invention is not limited in this respect, as installer 180 may include any suitable collection of information.

Cloud storage 190 may include any one or more storage facilities, and cloud package 150, package 130 and installer 180 may be uploaded to cloud storage 190 in any particular manner, as embodiments of the invention are not limited to any particular implementation. For example, providers of some cloud computing services may make available a portal and/or other utility(ies) which a customer may use to upload or otherwise transfer (e.g., over the Internet) information for use by an application that is to be deployed to the cloud. Each of cloud package 150, package 130 and installer 180 may be uploaded to cloud storage 190 may be uploaded together, or in any suitable sequence. Embodiments of the invention are not limited in this respect.

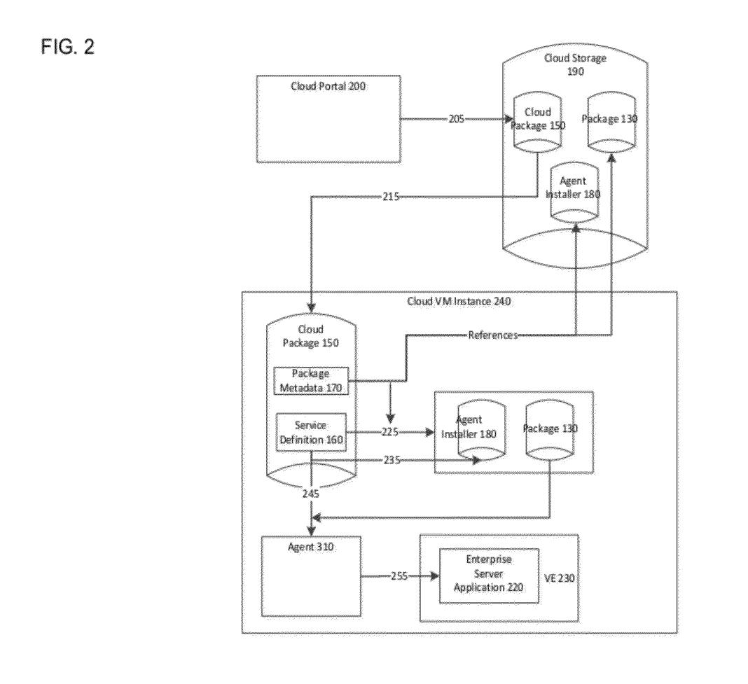

In the example depicted in FIG. 1, when cloud package 150, package 130 and installer 180 are uploaded to cloud storage 190, the application is set to be deployed to the cloud computing environment and made available to users. FIG. 2 depicts an example system and technique for deploying an application so that it may be exposed to users.

In the example of FIG. 2, cloud portal 200 initiates the deployment of the application at the instruction of a user, as indicated via arrow 205. Of course, a portal need not be employed to initiate application deployment, as any of numerous techniques may alternatively be employed, some of which may not involve receipt of instructions from a user. For example, a completely automated procedure may initiate the deployment of the application. If instructions from a user are involved, those instructions may be issued in any suitable manner, including via a portal and/or other facility(ies). Embodiments of the invention are not limited to any particular implementation.

In the example shown in FIG. 2, deployment of the application to the cloud computing environment is initiated by moving cloud package 150, described above with reference to FIG. 1, to cloud virtual machine (VM) instance 240, as indicated via arrow 215. It should be appreciated, however, that not all embodiments of the invention may initiate deployment by transferring information to a virtual environment, or may employ a virtual environment at all. For example, some embodiments may initiate deployment to one or more physical machines, or to some combination of physical and virtual machines. Embodiments of the invention are not limited to being implemented in any particular manner.

In the example shown, cloud package 150 is configured so that, once deployed to cloud VM instance 240, it begins a download of agent installer 180 and package 130 from cloud storage 190, as indicated by arrow 225. Information included in service definition 160 causes agent installer 180 to execute within cloud VM instance 240, as indicated by arrow 235, thereby installing agent 210. In the embodiment shown, execution of agent installer 180 draws on data specified in package 130, so that agent 310, when installed, includes resources needed by application 220 for proper execution. For example, as described above with reference to FIG. 1, installed agent 210 may provide resources such as registry keys which application 220 expects to be able to modify during execution, files which the application expects to be able to create or open, data to which application 220 expects access, etc. As a result of agent 210 providing these resources, application 220 may execute properly in the cloud computing environment without substantial modification. Of course, these resources may be provided to application 220 using any suitable technique, which may or may not include execution of an agent. Further, any of numerous types of resources may be provided, as embodiments of the invention are not limited in this respect.

In the example shown in FIG. 2, agent 210 adds the resources used by application 220 to virtual environment (VE) 230, and prepares application 220 for execution in the virtual environment, as indicated via arrow 255.

Preparing application 220 for execution may include performing any of numerous tasks. For example, in some embodiments, agent 210 may map one or more configuration aspects of application 220 to corresponding configuration aspects of an application model implemented by the cloud computing system. For example, application 220 may be configured to make calls to functions implemented by an operating system (i.e., when implemented in a non-cloud environment) via one or more application programming interfaces (APIs). In some embodiments, preparing application 220 for execution may include “hooking” one or more of these APIs, so that when application 220 attempts to call a particular function, a corresponding function provided by the cloud computing environment is called instead. As one example, if application 220 attempts to call a function, typically provided by an operating system under which the application is installed, to create a file, then hooking the API may allow the call to be intercepted and a corresponding function provided by the cloud computing platform to instead be invoked. As a result, application 220 may be provided with various tools and/or resources, to which it expects to have access to execute properly, without those resources being actually made available by the physical hardware on which the application executes, and without application 220 having to be substantially modified for this to occur. Preparing application 220 for execution may also include implementing one or more interfaces, registered with the cloud computing system, for performing various actions with respect to application 220. The interface(s) may enable such actions to be performed as starting application 220, stopping it, reconfiguring it, etc. Any suitable interface(s) may be implemented to enable any suitable action(s) with respect to application 220, as embodiments of the invention are not limited in this respect.

Agent 210 then causes application 320 to execute, as indicated by arrow 255. At this point, application 220 has been provided with the resources which it needs to execute properly, so that it may execute within the virtual environment 230 provided by cloud VM instance 240, without substantial modification to application 220 being needed.

It should be appreciated that providing application 220 with a package of resources which it uses during execution not only allows it to be installed within VE 230, but within any virtual (or non-virtual) environment in which this package is provided. Thus, if a provider of the cloud computing platform on which the application executes decides that the application should be moved to another environment, the package may be moved along with the application to provide for the application's continued proper execution. Thus, the provider may move the application amongst environments without disrupting its availability to end users.

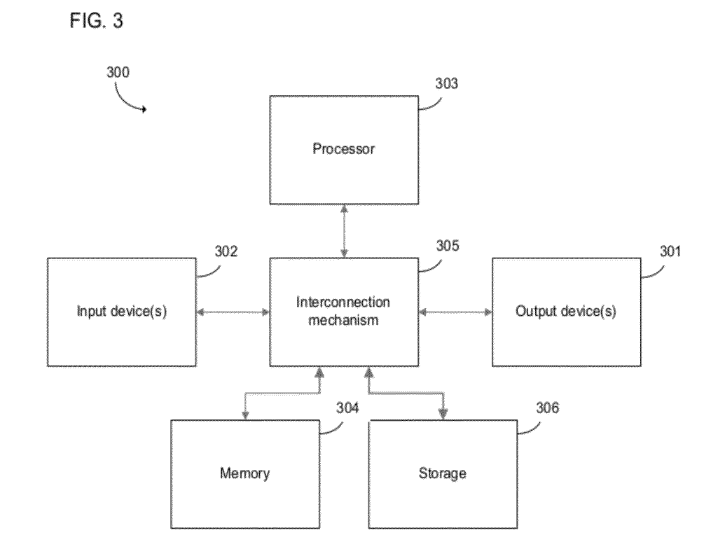

Various aspects of the systems and methods for practicing features of the present invention may be implemented on one or more computer systems, such as the exemplary computer system 300 shown in FIG. 3. Computer system 300 includes input device(s) 302, output device(s) 301, processor 303, memory system 304 and storage 306, all of which are coupled, directly or indirectly, via interconnection mechanism 305, which may comprise one or more buses, switches, networks and/or any other suitable interconnection. The input device(s) 302 receive(s) input from a user or machine (e.g., a human operator), and the output device(s) 301 display(s) or transmit(s) information to a user or machine (e.g., a liquid crystal display). The input and output device(s) can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

The processor 303 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

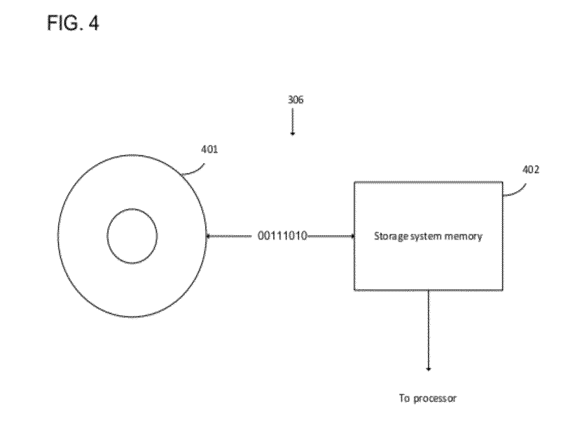

Processor 303 may also execute one or more computer programs to implement various functions. These computer programs may be written in any type of computer program language, including a procedural programming language, object-oriented programming language, macro language, or combination thereof. These computer programs may be stored in storage system 306. Storage system 306 may hold information on a volatile or non-volatile medium, and may be fixed or removable. Storage system 306 is shown in greater detail in FIG. 4.

Storage system 306 may include a tangible computer-readable and -writable non-volatile recording medium 401, on which signals are stored that define a computer program or information to be used by the program. The recording medium may, for example, be disk memory, flash memory, and/or any other article(s) of manufacture usable to record and store information. Typically, in operation, the processor 303 causes data to be read from the nonvolatile recording medium 401 into a volatile memory 402 (e.g., a random access memory, or RAM) that allows for faster access to the information by the processor 303 than does the medium 401. The memory 402 may be located in the storage system 306 or in memory system 304, shown in FIG. 3. The processor 303 generally manipulates the data within the integrated circuit memory 304, 402 and then copies the data to the medium 401 after processing is completed. A variety of mechanisms are known for managing data movement between the medium 401 and the integrated circuit memory element 304, 402, and the invention is not limited to any mechanism, whether now known or later developed. The invention is also not limited to a particular memory system 304 or storage system 306.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers and/or systems. Such processors may be implemented as integrated circuits, with one or more processors in an integrated circuit component, though a processor may be implemented using circuitry in any suitable format.

It should be appreciated that any component or collection of components that perform the functions described herein can be generically considered as one or more controllers that control the above-discussed functions. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories, or a combination thereof.

It should also be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound-generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual environment.

In this respect, the invention may be embodied as a computer-readable medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer-readable storage medium) encoded with one or more programs that, when executed on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in the illustrative embodiments described herein.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. In a cloud computing system in which an application is not permitted to store state information in an environment in which the application executes, a method comprising:
(A) enabling a particular application that is configured to store state information in an environment in which it executes to execute in the cloud computing system.

2. The method of claim 1, wherein, while executed in an environment in which local storage of state information is permitted, the particular application employs a set of resources, and wherein (A) comprises providing a package comprising the resources employed by the application during execution.

3. The method of claim 2, wherein the package enables the application to perform actions comprising changing a registry entry and creating a file, without modifying an operating system in the cloud computing system.

4. The method of claim 1, wherein (A) comprises enabling the particular application to execute in a first environment in the cloud computing system, and wherein the method further comprises:
(B) causing the particular application to be moved from the first environment to a second environment.

5. The method of claim 4, wherein the particular application employs a set of resources, (A) comprises providing a package comprising the resources employed by the application during execution, and (B) comprises causing the package to be moved to the second environment for use by the particular application during execution in the second environment.

6. The method of claim 1, wherein the cloud computing system implements an application model, and wherein (A) comprises providing a service definition for the particular application, the service definition being specified in relation to the application model.

7. The method of claim 6, wherein the service definition specifies one or more of a port employed by the particular application during execution and a certificate used by the particular application for authentication.

8. The method of claim 1, wherein (A) comprises enabling the particular application to execute in a first environment in the cloud computing system, and wherein the first environment is a virtual environment.

9. A cloud computing system, comprising:
at least one storage facility; and
at least one microprocessor, programmed to:
monitor execution of an installer for an application, the application being configured to store state information in the environment in which it executes, the monitoring identifying resources used by the application during execution;
create a package comprising resources used by the application during execution, the resources enabling the application to store state information during execution;
enable a user of the cloud computing system to transfer the application and the package to the at least one storage facility;
wherein the cloud computing system does not permit an application to store state information in an environment in which the application executes.

10. The cloud computing system of claim 9, wherein the at least one storage facility stores information defining an application model for the cloud computing system, and wherein the at least one processor is programmed to create a cloud package comprising information useful for enabling the application to execute on the cloud computing system, the cloud package being defined in relation to the application model.

11. The cloud computing system of claim 10, wherein the cloud package comprises a service definition and metadata useful for enabling the application to execute on the cloud computing system.

12. The cloud computing system of claim 11, wherein the service definition specifies a port used by the application during execution, and specifies one or more certificates used by the application for authentication.

13. The cloud computing system of claim 9, wherein the at least one processor is programmed to enable the transfer of the application by providing a portal which enables transfer to the cloud computing system.

14. The cloud computing system of claim 13, wherein the portal further enables deployment of the application on the cloud computing system, the deployment causing the application to be made available to an end user.

15. The cloud computing system of claim 9, wherein the at least one processor is programmed to implement a virtual environment in which the application is to execute.

16. A tangible computer-readable storage medium having instructions encoded thereon which, when executed in a cloud computing system that does not permit an application to store state information in an environment in which the application executes, perform a method comprising:
receiving at least one instruction to deploy an application to the cloud computing system, the application being configured to store state information in an environment in which it executes, the at least one instruction identifying a package comprising resources employed by the application during execution, the resources enabling the application to store state information during execution.

17. The tangible computer-readable storage medium of claim 16, further comprising instructions defining a mapping of at least one configuration aspect of the application to an application model implemented by the cloud computing system.

18. The tangible computer-readable storage medium of claim 17, wherein the at least one configuration aspect comprises a particular operating system function that the application is configured to call, and the mapping defines a correlation between the particular operating system function and a function provided by the cloud computing system.

19. The tangible computer-readable storage medium of claim 16, further comprising instructions defining:
upon receiving the at least one instruction, installing the application on a virtual environment instance provided by the cloud computing system, the installing comprising making the package available to the application within the virtual environment instance so that the application is able to store state information within the virtual environment instance during execution.

20. The tangible computer-readable storage medium of claim 16, further comprising instructions defining providing a portal through which the at least one instruction is received from a user.
